(19) United States
(12) Patent Application Publication
(10) Pub. No.: US 2003/0049850 A1
(43) Pub. Date: Mar. 13, 2003

(54) Enhanced detection of metal plating additives

(76) Inventor: Josh H. Golden, Santa Cruz, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/242,388

(22) Filed: Sep. 11, 2002

Related U.S. Application Data
(60) Provisional application No. 60/322,825, filed on Sep. 12, 2001.

(51) Int. Cl. G01N 21/64

(52) U.S. Cl. 436/56; 436/164

(57) ABSTRACT

A method for detecting and quantifying analytes such as chemical additives in metal plating bath solutions is provided. Molecular tags are incorporated into the chemical structure of the analytes of interest to affect the spectral properties of the resulting analyte-tag complexes such that they are more readily detectable in the plating bath solution by absorbance, fluorescence, or Raman spectroscopic methods.

### RELATED APPLICATIONS

This application claims the benefit of U.S. Provisional Application Serial No. 60/322,825, filed on Sep. 12, 2001, the disclosure of which is hereby incorporated by reference in its entirety. This application is also related to copending U.S. patent application Ser. No. 10/196,491 filed on Jul. 15, 2002, the disclosure of which is also incorporated herein by reference.

### FIELD OF THE INVENTION

The present invention relates generally to the field of metal plating. More specifically, the present invention relates to methods of enhancing the detection of analytes in metal plating solutions by incorporation of a chemical functionality to the molecular structure of the analytes.

### BACKGROUND OF THE INVENTION

Metal plating is used in a wide variety of industrial processes. Plating systems, in which an object is placed in a plating solution to apply a metallic coating to the object, are well known in the art. Metal plating is used to plate a variety of metals, such as for example copper, zinc, nickel and gold. Many metals are plated simply by immersion in a metal plating bath, or electroplated when electrodes are placed in the bath. Copper plating has received significant interest due in part to its application to the semiconductor industry. Semiconductor fabrication includes the formation of different layers of material on substrates to form conductors and insulators to create integrated circuit patterns.

New generations of integrated circuits (ICs) increasingly are carrying electronic signals through copper wiring because metal wiring resistance and capacitance effects have become a limiting factors in microprocessor speed. This effect is generally referred to as RC delay. Because the transistor switching speed is no longer the limiting factor, a great deal of attention has focused on the successful integration of lower resistance copper wiring and low-dielectric constant materials to reduce RC delay. Copper wiring has approximately 40% lower resistance than conventional aluminum conductors and is deposited by the electrolytic or electroless filling of copper into trenches etched in a dielectric material. The copper wiring is connected to other wiring levels by a “via” of either tungsten or copper metal. The process of inlaying copper as both the wire and via in a dielectric trench is called the “dual damascene process.” The damascene process differs from that used to form aluminum lines in ICs because copper is difficult to uniformly sputter into trenches, it does not etch well, and it does not typically form volatile byproducts which can be removed during processing. For comparison, aluminum metallization is achieved by physical vapor deposition (PVD) or sputtering of aluminum metal onto the substrate, followed by masking and subtractive etching to form the lines of electronic conduction.

Two process steps must be applied prior to a copper inlaying step in a semiconductor processing system. First, a barrier layer of TaN, TiN, SiC, or the like is deposited into the trench by PVD to prevent the diffusion of copper into the dielectric. Then, a uniform seed layer of copper is deposited onto the trench liner to serve as a substrate for copper nucleation and film formation. The copper seed layer is typically deposited using a directional ion beam. It is imperative that both the liner and copper seed layers are of uniform thickness and are chemically and physically homogeneous so that subsequent filling of the trench with copper metal is free of defects and voids. Production of homogeneous barrier and seed layers is expected to become even more challenging in the future as trench aspect ratios continue to increase to as high as 10:1 (0.1 μm wide×1.0 μm deep), and device dimensions and line widths shrink in accordance with Moore's Law.

After the deposition of barrier and seed layers, the inlay of copper may be achieved by electrolytic copper plating, in which the silicon wafer, or substrate, serves as the cathode. A sacrificial copper anode completes the circuit. The key to this process is filling of the trench from the bottom up. Otherwise, opposing sides of a deep vertical trench or via tend to grow together and “pinch off,” forming voids which negatively affect device integrity. A more detailed review of IC metallization and semiconductor processing may be found in H. Xiao, Introduction to Semiconductor Manufacturing Technology, Prentice Hall, New Jersey, 2001.

Special inorganic and organic based additives are typically added to an acidic electrolytic copper sulfate solution to facilitate filling of the trenches with copper from the bottom up. Electrolytic plating additives are critical in the filling of high aspect ratio trenches and the production of defect free morphology. These additives typically include accelerators, brighteners, suppressors, and levelers, and are generally organic-based molecules or macromolecules. Chloride ions are also occasionally introduced to enhance adsorption of certain organic additives. Many of these additives and the bath formulations are proprietary formulations. However, in general, accelerators are small organic molecules containing sulfide or disulfide groups such as sulphopropyl sulfides or sulphopropyl disulfides.

In the manufacture of integrated circuits using copper damascene processing, small accelerator molecules migrate into the trench and increase the rate of copper deposition in the trench from the bottom of the trench upward. Accelerators are chemically active molecules that coordinate with copper ions to mediate the transfer of electrons. Accelerator molecules are directly consumed during the plating process and decompose to a variety of byproducts. Brighteners are typically small molecules such as formaldehyde, or in some cases, sulfides or disulfides, that affect the grain size of the plated copper. Grain size is important with regards to annealing and crystal structure which ultimately affects conductivity. Coarse grain sizes tend to diffract light, while smaller grain sizes are more reflective (thus the origin of the name brightener).

Suppressors are usually low molecular weight macromolecules, such as, for example polyethers, with molecular weights in the approximate range of 2000 to 5000 grams per mole. They serve as grain size refinement aids or as mediators to regulate the reactivity of accelerators near the top of trenches that are being filled. This suppressing action, which typically occurs by surface adsorption, prevents metal from rapidly spilling over the side of a filled trench or overflowing out of the trench. Due to size constraints, suppressor macromolecules cannot get into the very small trench, but rather are thought to migrate and collect at the top comers of the trench or at the surface. Suppressor molecules are also consumed during the plating process via decomposition or chain cleavage. Chloride ions are typically introduced to aid the adsorption of the suppressor.

Levelers are used to passivate the top surface on the outside of the trench in a dual damascene copper plating process for IC interconnects. Levelers are usually macromolecules, with molecular weights that may approach approximately 1 million or more grams per mole. Similarly to suppressors, levelers mediate the rate of metal deposition by blocking accelerators outside of a trench. However, levelers are active well outside of the trench due to molecular size constraints. Levelers ultimately make the surface more level and smooth, which improves the efficiency of post-processing steps, such as for example chemical-mechanical polishing. Levelers are typically more resistant to decomposition and chain cleavage than suppressors. Some manufacturers interchangeably use the terms accelerator, brightener, suppressor, and leveler which may cause confusion, depending on the manufacturer, the application, and the plating formulation. The above simplified summary and description suffices for the purposes of the present invention. More detailed information on bath formulations and their behaviors can be found U.S. Pat. Nos. 4,347,108; 4,490,220; 4,786,746; 4,897,165; 5,252,196; and 5,730,854.

Despite its popularity, electrolytic plating has drawbacks. Electroplating is a wet processing technique that is very sensitive to process variations, which can lead to defects. In prior applications of electroplating the process has been rather loosely controlled. These prior techniques are not well suited to semiconductor fabrication which requires tightly controlled and high quality, reproducible processes. Another significant drawback of electroplating processes is maintaining the chemical purity of the plating bath and the desired composition and concentration of the various additives in the plating bath. This problem is of even greater concern when the metal plating process is used to plate metal on semiconductors. When plating bulk copper to form copper interconnects for example, the copper plating solution must be capable of producing a high quality copper layer without impurities or defects. Accordingly, there is a significant need for a method and system for accurately and quickly determining the presence of chemical species such as plating bath additives in metal plating solutions, and further the composition and/or concentration, and thus the purity, of such plating solutions.

Organic plating additives are typically very dilute in metal plating solutions. For example, the concentration of the organic additives in an electrolytic copper sulfate plating solution may range from less than 100 ppm or even lower than 1 ppm, depending on the formulation. In contrast, copper sulfate plating solutions typically contain many tens of grams per liter of copper and sulfate, usually in massive excess. As the plating process progresses, accelerator, suppressor, and leveler additives are consumed to varying degrees and must be replenished. In prior art systems, replenishment is typically achieved either by complete dumping of the bath or by a bleed and feed protocol in which fresh additive solutions and/or a complete replacement bath is slowly fed into the active bath while the old bath solution is drained away as in a continuous flow stirred tank reactor (CFSTR). This is an expensive and wasteful method of ensuring that the additive concentrations remain within optimal parameters.

Electroless plating is an alternative metal plating technique that has recently gained momentum in the fabrication of interconnect structures. Electroless plating involves the use of an in situ chemical reducing agent such as hypophosphite, dimethylamine borane, borohydride, formaldehyde and the like to reduce metals in solution. Electroless plating baths typically feature a variety of chemical components, both inorganic and organic, in concentrations that range from a few ppm to many grams per liter. In addition to the reducing agent and metal(s), there are other chemical species that have a profound effect on the performance of a bath. They include, but are not restricted to, pH buffer, complexing agents to prevent metal precipitation, and inhibitors, such as thiourea or other sulfur containing compounds that retard or mediate reaction kinetics. Electroless plating has certain advantages over electrolytic plating. For one, electroless plating deposits conformal metal coatings in high aspect ratio trenches. A variety of metals and metal alloys can be deposited directly from solution in this fashion. Electroless plating is especially effective for the deposition of barrier films such as cobalt tungsten phosphide (CoWP) and cobalt tungsten boride (CoWB) in high aspect ratio trenches, the deposition of copper seed, as well as copper fill. Electroless chemistries are expected to replace PVD barrier and seed and electrolytic plating deposition methods in IC manufacturing within the next five to eight years.

Because of the potential displacement of electrolytic plating and PVD techniques by electroless techniques, there is a need for an analytical technique for monitoring the constituents of an electroless plating bath over time. As in electrolytic plating systems, the composition of the various additives in an electroless bath must be tightly controlled to deposit high quality, defect-free films and layers. Currently, liquid chromatography (LC) and polarography are used to monitor these baths. LC requires manual injection of a sample in a column and a delay while the chemical species elute over time. The chemical species may be identified spectrophotometrically or on the basis of elution time when compared to known controls. This process takes typically 30 minutes or more, so it is not considered real-time monitoring. Moreover, because the additives in an electroless bath are present at very high concentrations, often on the order of grams per liter, LC analysis also requires that that the samples be diluted prior to injection, which introduces an additional labor intensive step to the process. Differential pulse polarography (DPP) is a voltametric technique that has been used to measure electroless plating bath constituents over the past several years. It involves the measurement of current as a function of voltage before and after voltage pulses. The difference between the two current measurements allows peak shaped curves to be obtained. The analyte concentration from these curves can thus be determined. While DPP is an effective off-line technique, it involves sample preparation, pH adjustment, and multiple iterations over approximately one-half to one hour period to obtain results. Moreover, it generates a mercury waste stream due to the use of a Hg drop electrode. Thus, there is a need for a real-time, in situ, quantitative method for analysis of electroless plating bath additives. Additional information on electroless deposition in IC manufacturing can be found in G. Malloy and J. Hajdu, Electroless Plating Fundamentals and Applications, Reprint Edition, Noyes, N.Y., 1990 as well as in to U.S. Pat. Nos. 5,695,810; 6,323,128; and 6,287,968, and Lopatin, et. al., in Characterization of Cu, Co, Ni and Their Alloys for ULSI Metallization, Conference Proceedings ULSI XIII, Materials Research Society, 1998.

Cyclic voltammetric stripping (CVS), or impedance measurements, have been used to monitor electrolytic plating bath performance by measuring the rate of metal plating, which is highly dependent on the additive concentration. With the CVS technique, the potential of the inert electrode is cycled at a constant rate in the bath, so that a small amount of metal is alternately plated and removed (stripping). The area under the stripping peak is proportional to the plating rate and thus the concentration of the additives and their ratio to one another. This technique is an indirect measurement of additive concentration, and thus solely depends on the ratios and concentrations of these components, as well as their synergistic interactions (both positive and negative). The CVS method is thus highly empirical and demands significant input from a highly skilled and experienced operator. Moreover, CVS and related methods may require analysis of bath chemistry in a chemistry lab and may also generate waste streams requiring special handling and disposal. Finally, CVS requires approximately 30 minutes or more to perform before a bath is qualified for use. Nonetheless, due to a lack of alternatives, metal plating industries and semiconductor plating operations have adapted CVS and related methods for electrolytic plating bath analysis and process control despite its limitations and expense. CVS is not applicable to analysis of electroless plating bath additives.

Because of the limitations of CVS and other available analytical methods for quantifying concentrations of metal plating bath additives, an improved analytical technique for measuring bath performance in relation to the additive concentration is highly desirable. Ideally, such a method would insure that the proper concentration of these materials are maintained, and that the process is stable. Spectroscopic methods are direct with results obtained in real-time and thus can be used for real-time process control with minimal lag time. A direct in situ spectroscopic method is preferable to an indirect method such as titration, LC, CVS or similar electrochemical analyses. However, because metal plating baths use water as a solvent and contain dissolved metal ions and/or complexes, typical spectroscopic absorption techniques are of little to no utility.

U.S. patent application Ser. No. 10/196,491 filed on Jul. 15, 2002 by Microbar System, Inc, entitled “Method and System for Analyte Determination for Metal Plating”, describes the use of Raman spectroscopy to quantitatively detect many of these additives. The advantage of Raman spectroscopy over UV-visible, fluorescent, and infrared absorption spectroscopy is that water and high amounts of dissolved copper sulfate and other metal ions typically do not interfere with Raman spectroscopy, depending on selection of a proper incident laser frequency and mode and frequency of detection of a particular Raman active functionality. Specifically, water does not scatter the incident laser light roughly between 300 and 800 nm, and aqueous metal ions do not interfere with the Raman detection of dilute organic additives in the wavelength range of approximately 300 to 600 nm. Therefore, Raman spectroscopy is useful for detection of plating bath additives. However, Raman spectroscopy has detection limits due to the inherent inefficiency of the Raman scattering process. Only about one out of a million photons can be scattered and detected in the Raman scattering process. While there are modem ways to overcome the inefficiency by using specialized techniques, fiber optics, and CCD detectors etc., conventional Raman spectroscopy is limited in detecting very dilute additives in metal plating solutions.

UV-visible, fluorescent, and infrared (IR) spectroscopic techniques are also severely limited in detecting very dilute additives in metal plating solutions because metal plating solutions are highly absorbing in the IR and UV-vis range. For instance, as illustrated in FIG. 1A, a typical electrolytic copper plating solution has a large absorption from approximately 200 nm to 340 nm wavelength, and also in the range of approximately 550 nm to 800 nm and longer wavelengths. Although there exists a small window where no interfering bath absorption occurs between 340 nm and 600 nm, most electrolytic plating bath additives do not absorb or fluoresce in this range.

Likewise, for the sample cobalt citrate electroless plating bath whose UV-visible absorbance spectrum is shown in FIG. 1B, the solution is highly absorbing for wavelengths below approximately 320 nm. Electroless plating baths present comparable difficulties in identifying and quantifying analytes. An additional band of high absorbance occurs with a peak at approximately 529 nm. There is a low absorbance region in the wavelength range between approximately 320 nm and 430 nm and also above approximately 580 nm. Analytes whose maximum absorbance falls outside of these relatively narrow regions of the spectrum may present difficulties for spectroscopic analysis as discussed above for electrolytic copper plating baths and electroless baths. Thus, there is a need for improved techniques for direct and quantitative detection and analysis of very dilute additives in highly absorbing metal plating solutions.

As an example of this effect, a leveler macromolecule for use in electrolytic plating baths may contain a phenyl group in its structure or repeating unit, either in the backbone or as a pendant group. Aromatic rings and other functionalities that include two or more conjugated carbon-carbon double bonds undergo photon absorptions due to the excitation of sigma (σ) or pi bonding (π) electrons to π* excited states. These absorptions are normally found in the range of 180 nm to 255 nm for aromatic ring compounds, depending on the ring substituent and/or ring substitution pattern. However, since the leveler absorption is completely obscured by the copper sulfate solution which is also highly absorbing at 250 nm as shown in FIG. 2, there is little to no utility in the use of UV-visible spectroscopy to monitor the concentration of the material. Infrared absorbance spectroscopy also has low utility because of the very strong water —OH vibrational band at about 3500 cm⁻¹ that obscures most chemical information, especially in an aqueous plating bath. Similar problems hamper the use of fluorescence and Raman spectroscopy with the added challenge that, for these applications, both the excitation and emitted light wavelengths should preferably lie in the low absorbance region or regions of the plating bath spectrum.

### SUMMARY OF THE INVENTION

Accordingly, it is an object of the present invention to provide a method of detecting and measuring the concentration of analytes in metal plating solutions. More specifically, the present invention provides a method of enhancing the detection of analytes in metal plating solutions by incorporation of a chemical “tag” into the molecular structure of an additive so that the additive can be more easily detected by UV-visible, fluorescence, or Raman spectroscopy.

In one embodiment of the present invention a method of detecting one or more analytes in a metal plating solution is provided wherein an absorbance spectrum of the plating bath is collected an analyzed to determine one or more regions of low absorbance. A molecular tag is chemically incorporated into the analyte to form one or more spectrophotometrically enhanced analyte-tag complexes. The plating bath is analyzed using a spectroscopic method to collect a plating bath spectrum that contains one or more peaks corresponding to each of the one or more analyte-tag complexes in the bath. Concentrations of each of the one or more analyte-tag complexes in the bath are quantified based on the height and/or area of the peaks corresponding to each of the analyte-tag complexes.

In another embodiment of the present invention, a method of detecting an analyte in a metal plating solution is provided wherein an absorbance spectrum of the plating bath is collected and analyzed to determine one or more regions of low absorbance. A molecular tag that has one or more absorbance bands in one of the regions of low bath absorbance is chemically incorporated into the analyte to form one or more spectrophotometrically enhanced analyte-tag complexes. The plating bath is analyzed using absorbance spectroscopy to collect a plating bath spectrum that contains one or more absorbance peaks corresponding to each of the one or more analyte-tag complexes in the bath. The concentrations of each of the one or more analyte-tag complexes in the bath are quantified based on height and/or area of the peaks corresponding to each of the analyte complexes.

In an alternative embodiment of the present invention, a method of detecting one or more analytes in a metal plating solution is provided wherein an absorbance spectrum of the plating bath is collected an analyzed to determine one or more regions of low absorbance. A fluorescent molecular tag whose excitation and emission wavelengths are in one of the regions of low bath absorbance is chemically incorporated into the analyte to form one or more spectrophotometrically enhanced analyte-tag complexes. The plating bath is analyzed using fluorescence spectroscopy to collect a plating bath spectrum that contains one or more fluorescent emission peaks corresponding to each of the one or more analyte-tag complexes in the bath. The concentrations of each of the one or more analyte-tag complexes in the bath are quantified based on based on height and/or area of the peaks corresponding to each of the analyte complexes.

In a further embodiment of the present invention, a method of detecting one or more analytes in a metal plating solution is provided wherein an absorbance spectrum of the plating bath is collected an analyzed to determine one or more regions of low absorbance. A molecular tag is chemically incorporated into the analyte to form one or more spectrophotometrically enhanced analyte-tag complexes. The molecular tag increases the intensity of Raman emissions from the analyte-tag complex in response to excitation by incident light at a wavelength in one of the regions of low absorbance. The plating bath is analyzed using Raman spectroscopy to collect a plating bath Raman spectrum that contains one or more Raman emission peaks corresponding to each of the one or more analyte-tag complexes in the bath. The concentrations of each of the one or more analyte-tag complexes s in the bath are quantified based on based on height and/or area of the peaks corresponding to each of the analyte complexes.

### BRIEF DESCRIPTION OF THE DRAWINGS

Other objects and advantages of the present invention will become apparent upon reading the detailed description of the invention and the appended claims provided below, and upon reference to the drawings, in which:

FIGS. 1A and 1B are UV-visible absorption spectra for plating bath solutions containing copper sulfate and sulfuric acid and cobalt citrate, respectively.

FIG. 2 is a UV-visible spectrum showing the interference of the copper sulfate plating solution with an aromatic leveler absorption at about 275 nm.

FIG. 3 is a schematic diagram of a flow chart illustrating the steps of a method for determining analyte concentrations in a plating bath according to one embodiment of the present invention.

FIGS. 4A, 4B, and 4C are representative absorbance spectra illustrating the method of the present invention for embodiments using absorbance, fluorescent, and Raman spectroscopy, respectively.

FIG. 5 shows the spectrum and chemical structure of Acridine Yellow G, a potential chromophore that could be used as a plating bath additive molecular tag to shift the absorbance band of the analyte-tag complex to a preferred region of the bath spectrum according to one embodiment of the present invention.

FIG. 6 shows the spectrum and chemical structure of Auromine O (Basic Yellow 2), a potential chromophore that could be used as a plating bath additive molecular tag to shift the absorbance band of the analyte-tag complex to a preferred region of the bath spectrum according to one embodiment of the present invention.

FIG. 7 shows the spectrum and chemical structure of Coumarin 343, a potential chromophore that could be used as a plating bath additive molecular tag to shift the absorbance band of the analyte-tag complex to a preferred region of the bath spectrum according to one embodiment of the present invention.

FIG. 8 shows the spectrum and chemical structure of Proflavine, a potential chromophore that could be used as a plating bath additive molecular tag to shift the absorbance band of the analyte-tag complex to a preferred region of the bath spectrum according to one embodiment of the present invention.

FIG. 9 shows the spectrum and chemical structure of Direct Yellow G, a potential chromophore that could be used as a plating bath additive molecular tag to shift the absorbance band of the analyte-tag complex to a preferred region of the bath spectrum according to one embodiment of the present invention.

FIG. 10 shows the spectrum and chemical structure of Acridine Orange Base, a potential chromophore that could be used as a plating bath additive molecular tag to shift the absorbance band of the analyte-tag complex to a preferred region of the bath spectrum according to one embodiment of the present invention.

FIG. 11 shows the spectrum for 6,8-difluoro-7-hydroxy-4-methylcoumarin in pH 9.0 buffer, a potential chromophore that could be used as a plating bath additive molecular tag to produce an analyte-tag complex featuring a fluorescent functionality with excitation and emission bands occurring in a preferred region of the bath spectrum according to one embodiment of the present invention.

FIG. 12 shows the spectrum for 7-amino-4-methylcoumarin in pH 7.0 buffer, a potential chromophore that could be used as a plating bath additive molecular tag to produce an analyte-tag complex featuring a fluorescent functionality with excitation and emission bands occurring in a preferred region of the bath spectrum according to one embodiment of the present invention.

FIG. 13 shows the spectrum for Cascade Blue dye-labeled bovine serum albumin in pH 7.0 buffer, a potential chromophore that could be used as a plating bath additive molecular tag to produce an analyte-tag complex featuring a fluorescent functionality with excitation and emission bands occurring in a preferred region of the bath spectrum according to one embodiment of the present invention.

FIG. 14 shows the spectrum for resorufin in pH 9.0 buffer, a potential chromophore that could be used as a plating bath additive molecular tag to produce an analyte-tag complex featuring a fluorescent functionality with excitation and emission bands occurring in a preferred region of the bath spectrum according to one embodiment of the present invention.

FIG. 15A shows a possible polymeric structure formed as a copolymer of a proflavin derivative and epichlorohydrin that incorporates some appropriate mole fraction of chromophoric monomer and could be used as a spectrophotometrically enhanced analyte-tag complex according tone embodiment of the present invention.

FIG. 15B shows a possible polymeric structure formed as a copolymer of an auromine derivative and epichlorohydrin that incorporates some appropriate mole fraction of chromophoric monomer and could be used as a spectrophomoterically enhanced analyte-tag complex according tone embodiment of the present invention.

FIG. 15C shows a possible polymeric structure formed as a copolymer of acrylamide (m) and acrylate tagged with a coumarin derivative (n) derivative that could be used as a spectrophomoterically enhanced analyte-tag complex according tone embodiment of the present invention.

FIG. 16 is an absorbance spectrum resulting from doping a model dye, tartrazine, in an acidic copper sulfate solution corrected for background absorption using an identical reference solution of acidic copper sulfate (17 g L⁻¹).

### DETAILED DESCRIPTION OF THE INVENTION

The present invention provides a method for detecting and quantifying chemical analytes in metal plating solutions. While the embodiments described herein describe copper electrolytic and cobalt citrate electroless plating solutions, the method of the present invention may be used for a variety of metal plating solutions, for a variety of different metals and alloys, including, but not restricted to nickel, cobalt, zinc, copper, etc. The plating technique may be electrolytic or electroless. Electroless plating, as discussed above, is performed at high or low pH values with chemical reducing agents, which are known and familiar to those skilled in the art.

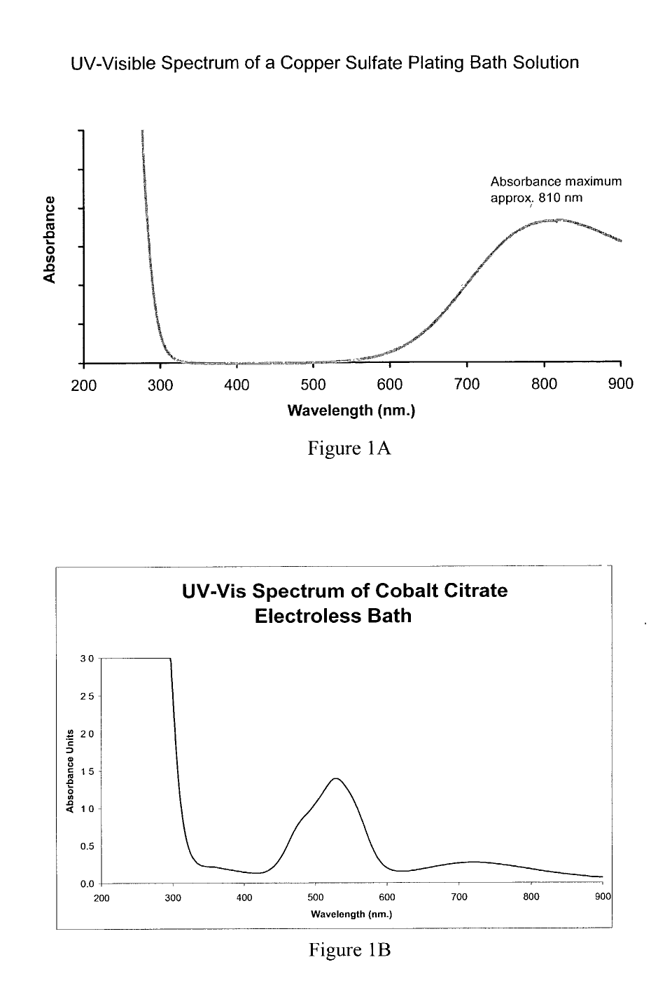

An electrolytic copper plating solution may contain plating additives such as accelerators, brighteners, suppressors, and levelers as detailed above. The concentrations of these additives in the copper plating solution is typically very low and may be in a range of approximately 0.1 ppm to 10 ppm depending on the formulation. In contrast, the concentration of copper and sulfate in the copper plating solution may be many grams per liter. Electrolytic copper plating solutions are highly absorbing due to water, sulfate, and copper in the infrared and UV-visible range between approximately 200 nm and 1000 nm with regions of very high solution absorbance below approximately 300 nm and above approximately 650 nm as shown in FIG. 1A. In electroless plating baths, the window of low background absorbance may be even smaller—between 320 to 430 nm, and also above 580 nm as illustrated in FIG. 1B.

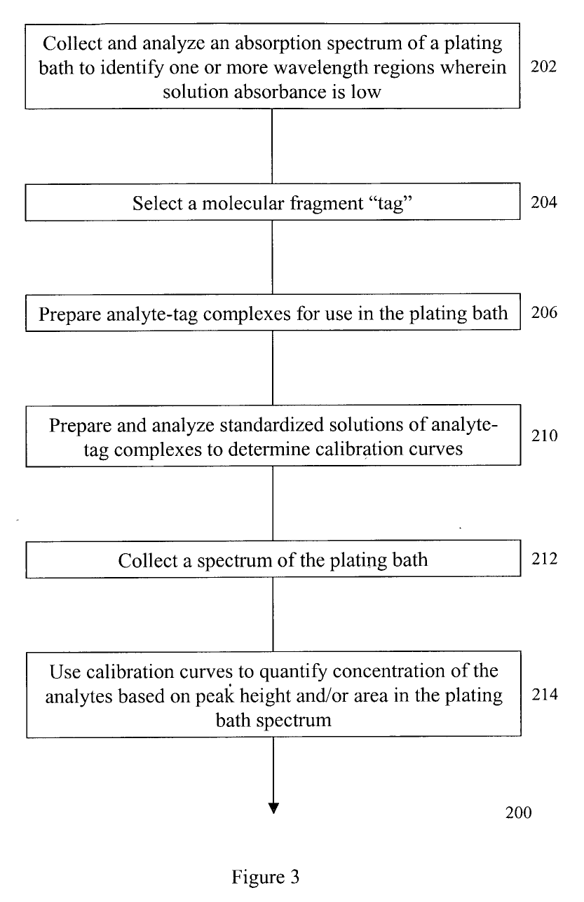

The method of the present invention is summarized in the flow chart 200 shown in FIG. 3. Based on a representative absorbance spectrum collected for a plating bath 202, one or more molecular “tags” are selected 204. These “tags” are chosen such that their spectrophotometric activity occurs in the region of the plating bath spectrum that is characterized by low overall absorbance. Plating bath additives are prepared chemically to include one or more of the selected tags 206. Standard solutions of the additive-tag complexes are prepared independently of the plating bath. These solutions are analyzed by spectroscopically to determine calibration curves for use in calculating additive concentrations based on peak height and/or area measurements from plating bath spectra 210. A spectrum of the plating bath containing tag-additive complexes is collected 212 and analyzed using the calibration curve or curves from step 210 to quantify the concentrations of the plating bath additives in the bath 214. The “tag” fragment may be tailored to enhance spectroscopic detection of the analyte of interest by shifting the maximum absorbance peak of the analyte-tag complex into a region of the plating bath spectrum in which background absorbance is low, by adding a fluorescent functionality to the analyte molecule that is detectable in a low absorbance region of the plating bath spectrum, or by adding a functional group or groups that have enhanced Raman spectroscopic emissions. Additional details on these specific embodiments are discussed in further detail below.

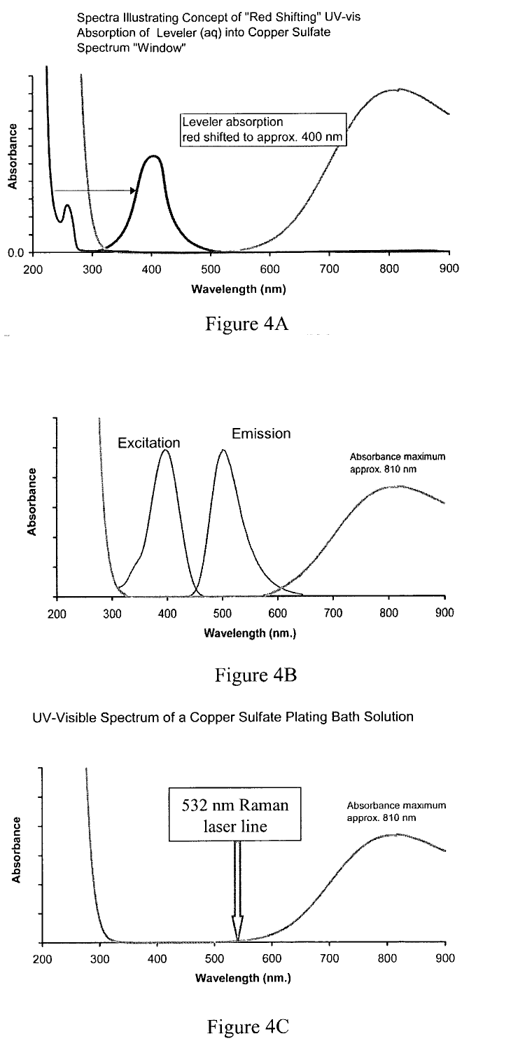

More specifically, the present invention provides a method of enhancing detection of analytes in metal plating solutions by incorporating a chemical functionality into the molecular structure of the analytes so that the analytes can be more easily detected by Raman, fluorescent, or UV-visible spectroscopy. In an electrolytic copper sulfate plating bath with an absorbance spectrum such as is shown in FIG. 1A, an absorbing functionality to be added to an analyte preferably absorbs in a wavelength range of approximately 325 to 550 nm as illustrated in FIG. 4A. For use of a fluorescent functionality to be detected by fluorescence spectroscopy, the excitation and emission wavelengths of the tagged analyte preferably fall within this range as shown in FIG. 4B. Raman spectroscopy is somewhat more flexible in that it is not limited to use of a single excitation wavelength. However, as with the absorbance and fluorescence spectroscopic embodiments, the Raman excitation light is preferably chosen at a wavelength or wavelengths that fall within the low absorbance region of the plating bath spectrum as shown in FIG. 4C. Similarly, for an electroless plating bath containing cobalt citrate such as is illustrated in FIG. 1B, the peak absorbance of the molecular tag preferably occurs at a wavelength other than the solution maximum absorbance at 529 nm. More preferably, the tagged analyte absorbs outside of the range of wavelengths between approximately 430 and 580 nm. Excitation of a fluorescent chromophore in a bath such as the electroless cobalt citrate solution of FIG. 1B is preferably at a wavelength other than 530 nm while emission outside of the absorption maximum of the solution in the range of approximately 430 to 580 nm is also preferred. Raman spectroscopy on a solution with the absorbance characteristics shown in FIG. 1B is preferably conducted with excitation light provided at a wavelength outside of the range of approximately 430 to 580. Because the electroless solution also exhibits a strong absorbance peak in the ultraviolet region of the spectrum, it is also preferable to operate at wavelengths above approximately 320 nm.

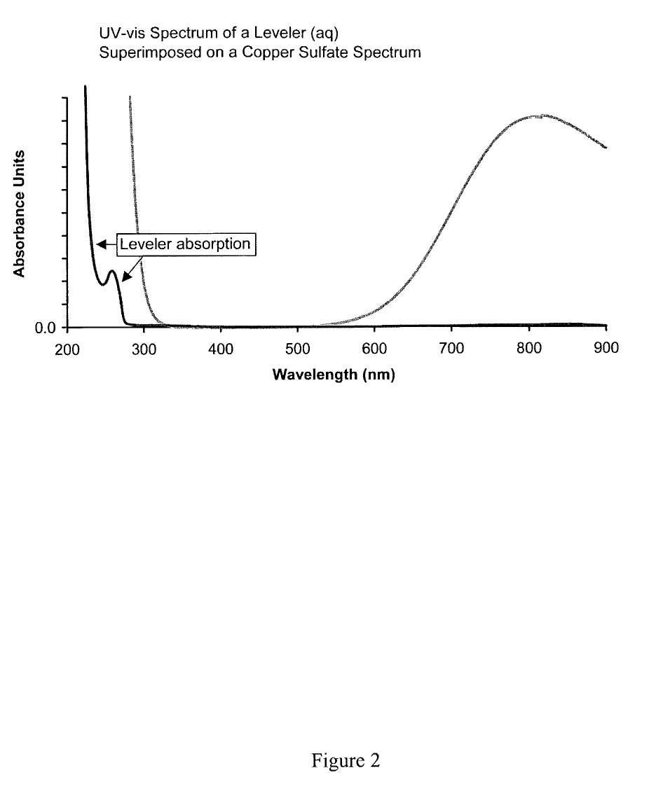

A wide variety of molecular tags are available both commercially and through chemical synthesis techniques which are known to those of ordinary skill in the art. Proper selection of a tag, however, is necessary to maximize the effectiveness of the method of the present invention. FIGS. 4A, 4B, and 4C illustrate the three conceptual embodiments of the present invention as it is applied to an electrolytic plating bath solution such as is shown in FIGS. 1A and 2. As noted above, typically used electrolytic plating bath additives tend to absorb light in the ultraviolet region of the UV-visible spectrum. The strong absorbance below approximately 300 nm of a concentrated copper sulfate solution, such as is used in electrolytic plating, tends to obscure usable spectroscopic information about compounds that absorb in the ultraviolet. The method of the present invention provides a solution to this difficulty in one or more of the three exemplary embodiments shown in FIGS. 4A-4C which respectively illustrate how molecular tags selected to shift the absorbance band of, add a fluorescent functionality to, or enhance the Raman emissions of an analyte molecule are used to facilitate identification and quantification of analytes in a copper sulfate plating bath solution. Although the method of the present invention is illustrated in detail by FIGS. 4A-4C for application to a copper sulfate electrolytic plating bath, it is well within the capabilities of one of ordinary skill in the art to apply the methods shown herein to other plating baths.

UV-visible absorbance spectroscopy is well known to those of ordinary skill in the art. According to one embodiment of the present invention, a light absorbing functionality (chromophore) or “tag” is incorporated into the molecular structure of the plating additive using modem techniques of chemical synthesis and molecular design. The chromophore thus incorporated enables detection of the analyte by shifting the absorption to a longer wavelength. One example of an application of this method to enhance detection of the leveler additive discussed previously with regards to FIG. 2 is illustrated in FIG. 4A. The wavelength shift of the absorption (red-shift) is preferably to a portion of the electromagnetic spectrum that is not obscured by the copper plating bath and thus may be readily detected by UV-visible spectroscopy. The light absorbing functionality may be preferably added to the additive molecule as a pendant group (hanging off of the macro-molecular chain structure of an additive) or as a structural piece of the molecule which is added during synthesis of the molecule. The chromophoric tag in the example shown in FIG. 4A is chosen to have a strong absorption band at approximately 400 nm. This band lies in the relatively low absorbance region of the copper sulfate plating bath spectrum. As such, quantitative information about the tagged additive may be obtained by collecting a UV-visible absorbance spectrum of the bath.

A red shift, or bathochromic shift is a shift of the UV-visible absorption of a chemical species to a longer wavelength. This shift may be due to due to a chemical group or functionality and/or a solvent effect. An empirical rule known as the Woodward-Fieser Rule is used to determine the maximum absorption of conjugated dienes, polyenes, enones, and dienones. For example, when a conjugated double bond or conjugated ring is added to a solitary benzene ring, the electrons are further de-localized through more π-orbitals in the larger molecule. As a result, the energy difference from the ground state to the excited state shrinks, and longer wavelengths are absorbed. This is typically shown in excitation of sigma (σ) or pi bonding (π) electrons to π* excited states in a UV-visible spectrum. As additional conjugated double bonds or aromatic rings are added, the electrons in the changed molecule are more de-localized, causing further red shift, or bathochromic shift. For example, benzene has an absorption at 184 nm. Naphthalene, which consists of two fused aromatic rings, has, an absorption at around 222 nm. Addition of a third aromatic ring to form anthracene produces an absorbance band at a wavelength of about 252 nm. A molecule with four conjugated aromatic rings, known as a tetracene, displays an absorption at about 300 nm. One of ordinary skill can achieve a red shift to a wavelength in the range of 350-1000 nm by using the appropriate chemical substitution on the analyte molecule or macromolecule. Accordingly, in one embodiment of the present invention, a chromophore is incorporated into the molecular structure of the plating bath additive after synthesis and isolation of the additive. In this case, the polymer or small molecule is chemically modified with chromophoric groups by modern techniques of chemical synthesis including nucleophilic substitution, metathesis, ring formation, aromatization, or other forms of chemical synthesis and bond formation known to those of ordinary skill in the art.

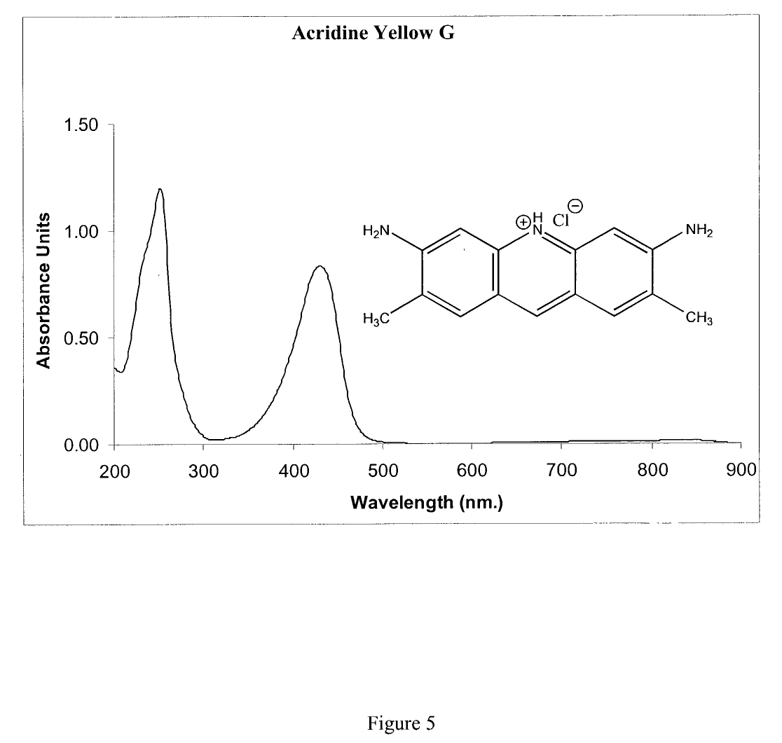

A broad range of molecular tags may be employed to produce this red shift, several of which are illustrated in FIGS. 5-10. In this embodiment, the existing analyte molecule is chemically modified by attachment of additional functionality to achieve the red-shift, or by attachment of a dye molecule or tag to the existing analyte molecular structure. By incorporation of absorbing chromophore functionality into an additive, the absorption of the additive is shifted from an area where it would be normally obscured by solution absorption, and into an area where it may more readily be detected by UV-visible spectroscopy. The absorbing functionality that is incorporated into the plating additives preferably includes organic molecules containing conjugated aromatic and heterocyclic aromatic groups that include carbon and/other main group elements, or transition metals. Various conjugated or chromophore groups known to one of ordinary skill, including aromatic rings, dienes, diynes, polyenes, nitrites, carbonyl, disulfides, and the like are preferably employed as absorbing functionalities. The chromophore may alternatively contain electron receiving or electron donating groups, including, but not limited to nitro, sulfonic acid, amino, or ethereal functionality, among others. The chromophore may also be an inorganic or organometallic complex, in which a metal center is coordinated by a number of ligands. The ligands may be inorganic, organic, or both. These complexes exhibit light absorption and/or fluorescence by a number of mechanisms, including metal center absorptions affected by the ligand crystal field, ligand to metal charge transfer, or by absorption/emission by the coordinated ligands themselves. Dye molecules coordinated to metals are known as mordant dyes. Phthalocyanine is one well known example. Metal-azo dye complexes are another example. The stereochemical orientation of the chromophore or attached functionality may also affect red shifting. For instance, cis, trans, double bond or steric orientation may all influence absorption properties. Ring substitution positions may also enhance red-shifting. Specific tag molecules that may be used include, but are in no way limited to acridine yellow, auromine-O (basic yellow 2), coumarin 343, proflavine, direct yellow 12, and acridine orange. However, a broad range of organic dye molecules may be employed. Chemical synthesis techniques necessary to form tag-analyte complexes including the molecules specifically recited herein as well as a host of other candidates are well known to those of ordinary skill in the chemical arts.

Further background information regarding coordinated metal centers and their UV-visible spectra can be found in a number of books on inorganic and organometallic chemistry including: R. H. Crabtree, The Organometallic Chemistry of the Transition Metals, 3rd Edition, John Wiley & Sons, New York, 2000, ISBN: 0471184233; F. A. Cotton, Advanced Inorganic Chemistry, John Wiley & Sons, New York, 1999; and Greenwood and Eamshaw's Chemistry of the Elements, Pergamon Press, New York, 1986. Additionally, many examples of absorbing and fluorescing chromophoric functionality and dye molecules can also be found in Langes Handbook of Chemistry, McGraw Hill, N.Y., 1992, 14th ed., pp. 7.17-7.28, The Chemistry of Synthetic Dyes and Pigments, Vol. 1-7, Academic Press, New York, 1952-1974, in various sections on dyes in the Kirk-Othmer Concise Encyclopedia of Chemical Technology, Wiley-Interscience, New York, 1985, or the 25-volume Kirk-Othmer Encyclopedia of Chemical Technology, Wiley-Interscience; 1998, ISBN: 0471527041; and E. N. Abrahart, Dyes and Their Intermediates, Pergamon Press, London, 1977.

The chromophoric or light absorbing group may contain any elements from the periodic table. Preferably, the chromophore contains, but is not restricted to carbon, hydrogen, oxygen, nitrogen, or sulfur. The chromophore, or part of the chromophore, may be a charged salt, to impart water solubility if needed, or to modify its surface tension. The absorbing functionality or “tag” is incorporated into an additive via a covalent chemical bond, ionic association, or hydrogen bonding. If the additive is a polymer such as a leveler, the tag is attached at the backbone or, alternatively, as a pendant group of the polymer.

In a preferred embodiment of the present invention, the absorbing functionality is a dye molecule. The dye molecule is attached onto a plating bath additive such as, for example, a leveler so that the UV-visible absorption band of the molecule is shifted into the range of approximately 350 nm to 650 nm and more preferably into the range of approximately 350 to 450 nm. The dye molecule may be charged, either negatively, positively, or both (zwitterionic) and may contain nitrogen and sulfur. Examples of dye molecules include and are not restricted to: nitroso, nitro, azo diazo, triazo, polyazo, azoic, stilbene, carotenoid, diphenylmethane, triarylamine, xanthene, acridine, quinoline, methine, thiazole, idamine, azine, oxazine, thiazine, thionated aromatic, aminoketone, hydroxyketone, anthraquinone, indigoid, phthalocyanine, and the like. Many of these dyes and their absorption maxima may be found in the aforementioned references. Many of the dyes may also be fluorescent. It is important to note that the preferred choice of a dye depends not only on its excitation and or emission response and thus detection, but also on its solubility and chemical stability in the plating bath media. Some dyes are more suitable for acidic conditions while others are more preferable for alkaline conditions. The specific choice of a dye molecule or molecules for use in labeling plating bath additive molecules depends on bath conditions (for example whether the bath is acidic or alkaline) as well as the ability of a dye or dyes to absorb in the appropriate range for detection and to be conveniently be chemically attached or incorporated into a plating bath additive molecule without interfering with the primary functionality of the additive molecule.

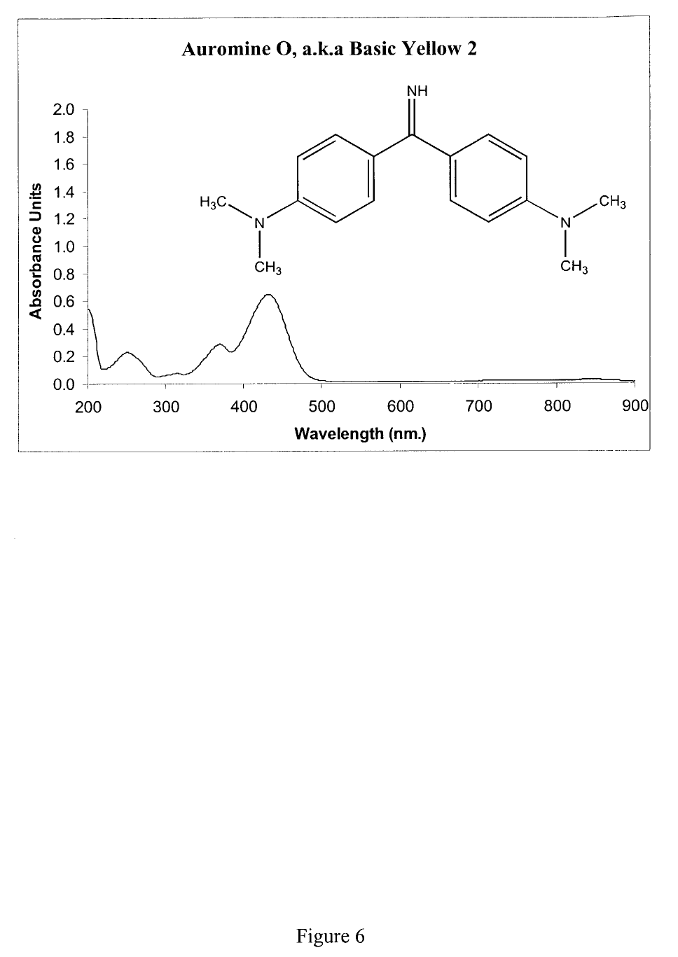

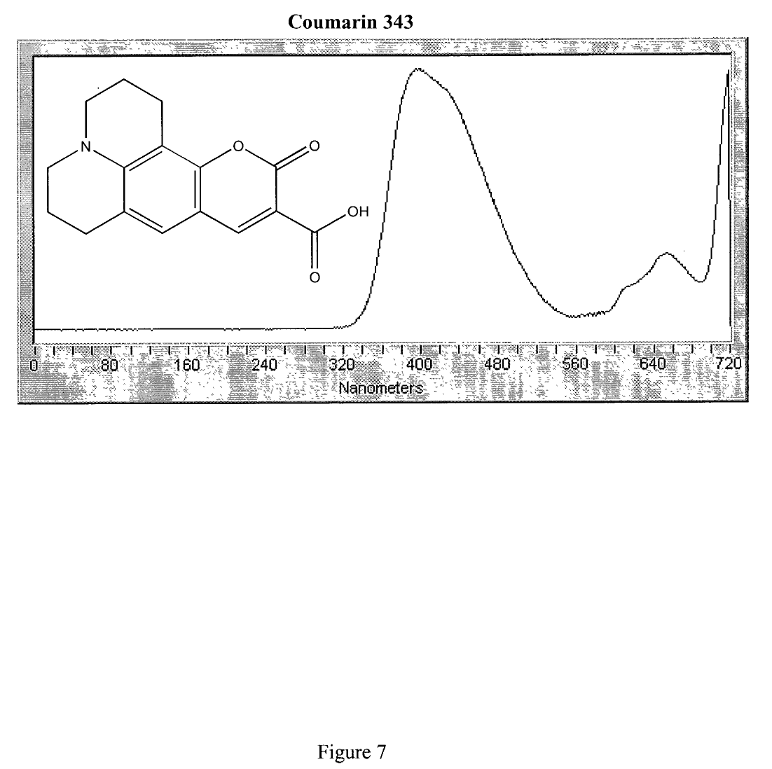

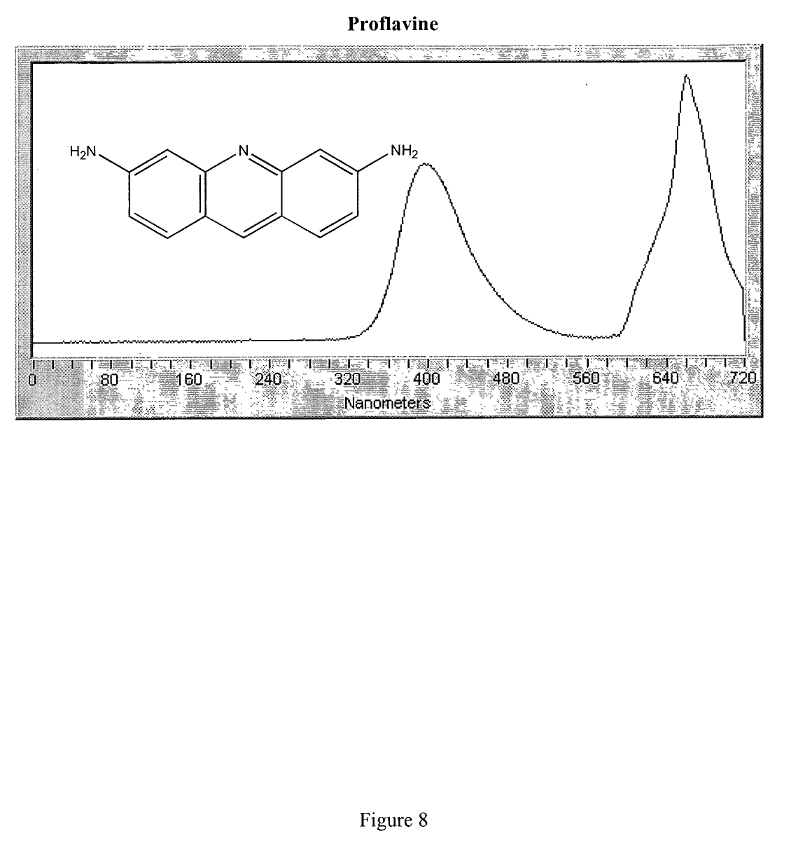

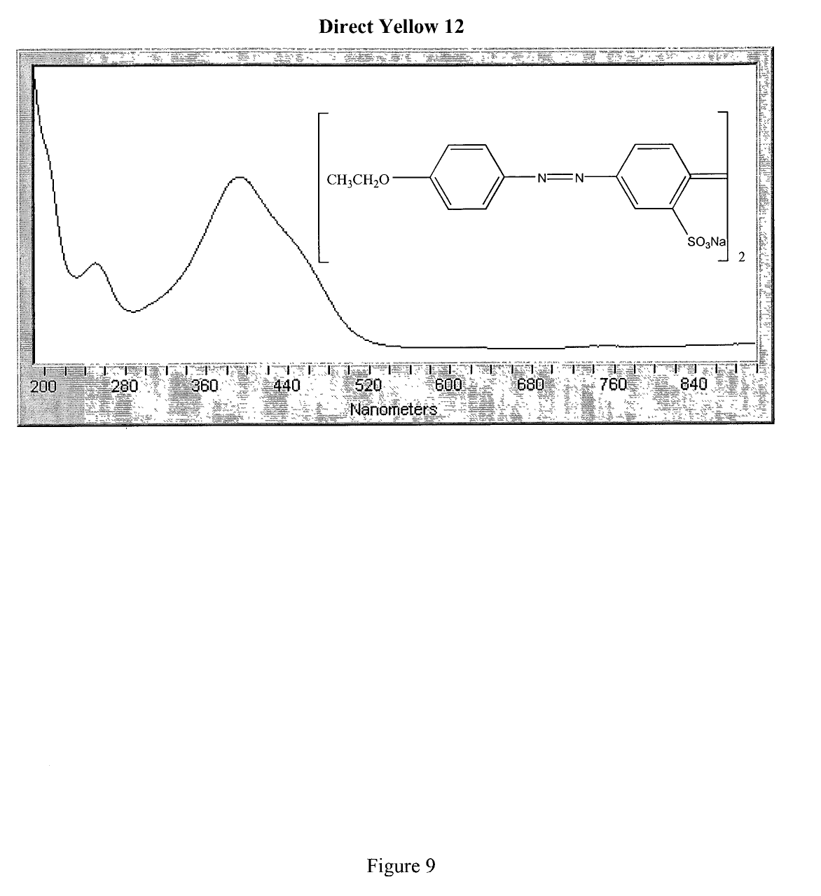

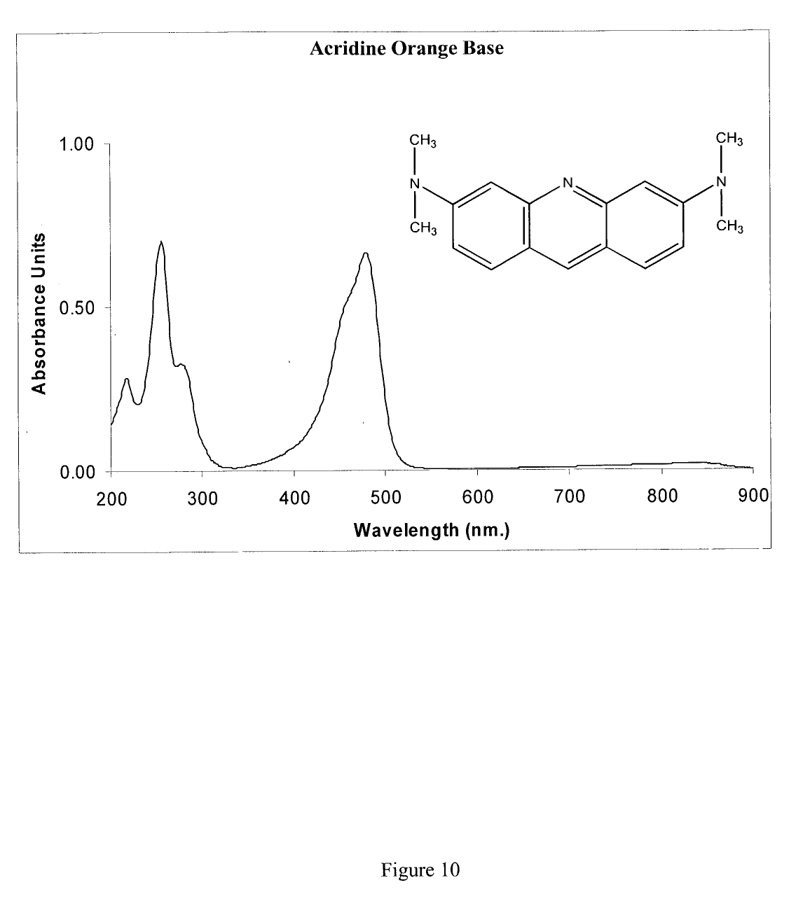

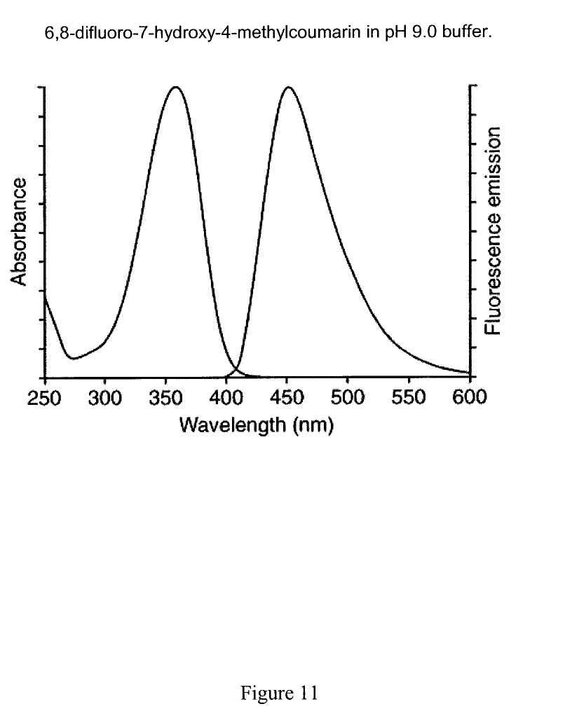

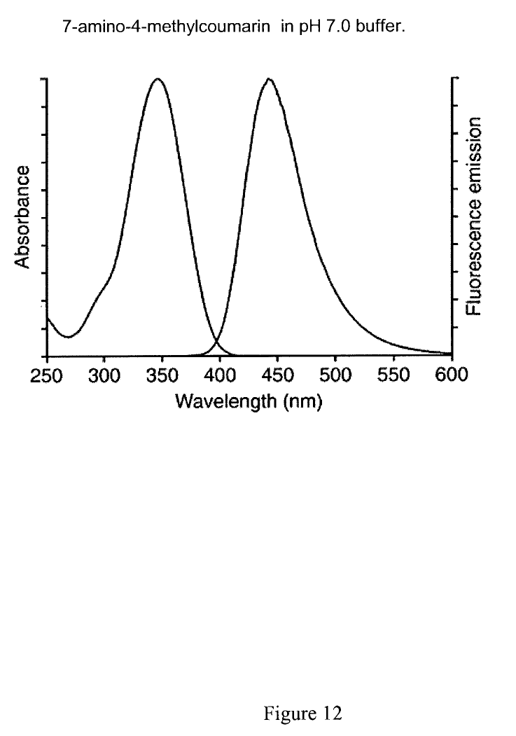

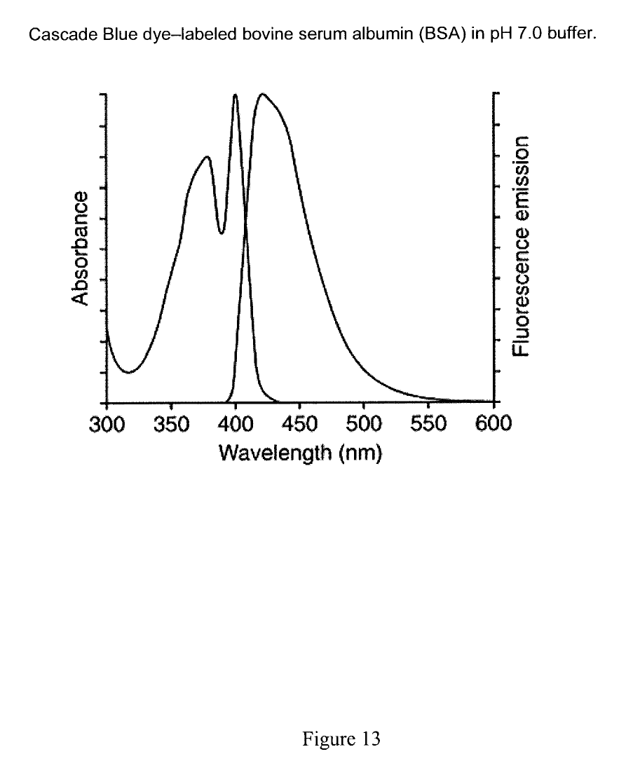

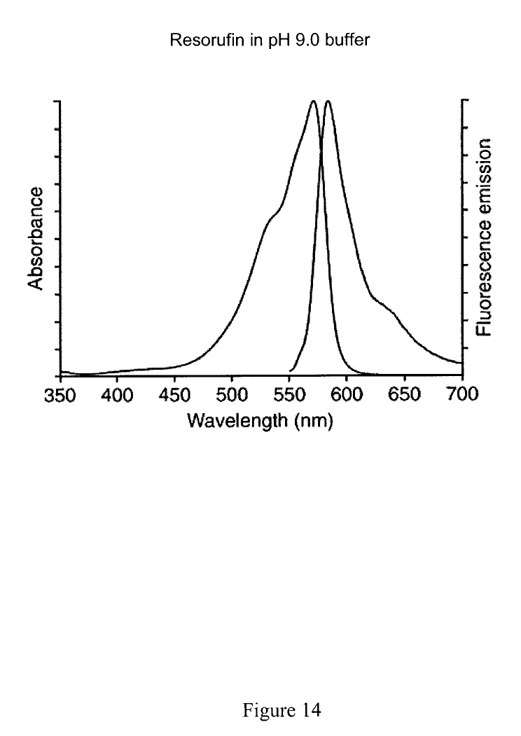

Referring, again to FIGS. 5-10, we supply a few illustrative examples of the practical applicability of the method of the present. Addition of one or more of the exemplary chromophore structures to a plating bath additive or other analyte molecule creates a molecule whose resulting UV-visible absorbance spectrum contains spectral features that are detectable despite the strong background absorbance of the plating bath solution in which the analyte resides. For instance, as noted in reference to FIGS. 1A and 1B, a copper sulfate solution such as an electrolytic plating bath absorbs strongly below approximately 300 nm and also above approximately 600 to 650 nm. For an analyte whose main absorption band lies in the ultraviolet region obscured by the solution absorption, a red shift as described above renders the molecule detectable and quantifiable. For an electroless bath containing cobalt citrate as illustrated in FIG. 1B, the solution absorbance spectrum has windows between approximately 320 and 430 nm and also above approximately 580 nm. FIG. 5 shows the molecular structure and UV-visible absorbance spectrum of Acridine Yellow G. As FIG. 5 shows, this molecule has an absorbance maximum at approximately 420 nm—well within the low absorbance window for both an electrolytic and an electroless plating bath. Likewise for Auromine O/Basic Yellow 2 whose spectrum and structure are shown in FIG. 6. This molecule has an absorbance maximum at approximately 440 nm. While this is ideal for use in an electrolytic bath, other choices might be superior in an electroless plating bath as the absorbance of the chromophore might be more difficult to detect on the shoulder of the large solution peak at 529 nm. Coumarin 343, shown in FIG. 7, has a strong absorbance peak at approximately 400 nm and is thus applicable for use in tagging analytes in both electrolytic and electroless solutions. The additional peak at approximately 715 nm shown in FIG. 7 might also be quantifiable in an electroless solution. Proflavin, shown in FIG. 8, also has two strong absorbance peaks, one or both of which could be expected to lie outside of the solution absorbance maxima regions for both electrolytic and electroless solutions. Likewise, Direct Yellow 12 and Acridine Orange Base, whose spectra and structures are shown in FIGS. 9 and 10, respectively, have absorbance peaks at approximately 380 nm and 490 nm. Direct Yellow 12 would thus be applicable for use in the copper sulfate solution of FIG. 1A and the electroless solution of FIG. 1B. The utility of Acridine Orange Base for tagging analytes is diminished in a solution such as that of FIG. 1B because the solution absorbance peak at 529 nm would mostly obscure the chromophore absorbance at approximately 490 nm. As noted, these examples are merely illustrative. Selection of a specific chromophore for use in tagging analytes in a metal plating bath may be applied on a case by case basis using the method of the present invention. The actual molecule used will depend on a variety of factors including available synthetic techniques for incorporating the chromophore into the analyte molecule. Furthermore, some routine experimentation may be necessary as inclusion of a chromophore molecule fragment into a larger molecular structure may cause some shifting of the absorbance maxima due to steric and entropic changes. Resolution of these and other issues is achievable through routine experimentation for one of ordinary skill in the art.

In another aspect of the present invention illustrated in FIG. 4B, the method of detecting additives in metal plating solutions is carried out using fluorescence techniques. Fluorescence spectroscopy operates slightly differently than absorbance spectroscopy. Rather than illuminate the solution with a broad range of wavelengths and measure transmittal of light and by subtraction absorbance, in fluorescence spectroscopy, the tendency of some molecules to absorb light at one wavelength and then reemit the light at a longer wavelength is exploited. Incident light at the proper excitation wavelength excites electrons from the ground π state to an excited π* state. The molecule then emits light at a longer wavelength than the excitation wavelength as the electrons relax to the ground state. Specific excitation and emission wavelengths vary by molecule, so fluorescence spectroscopy provides a valuable means of targeting specific analytes that is not available for straight absorbance spectroscopic methods. The objective is to excite the tagged molecule with radiation at a given wavelength, and then detect emission at another wavelength. In the method of the present invention, both the excitation and emission wavelengths of the fluorescent compound are preferably not obscured by the plating bath solution. FIG. 4B shows an example of an application of this method to quantify an additive molecule in the exemplary electrolytic copper sulfate plating bath solution shown in FIG. 1A. Examples of common fluorescent molecules that may be used include xanthene (λ_{excite}=315 nm, λₑₘᵢₛₛᵢₒₙ=435 nm) and its derivatives and quinine (λ_{excite}=350 nm, λₑₘᵢₛₛᵢₒₙ=450 nm) and its derivatives. U.S. Pat. Nos. 4,813,973; 5,171,450; 5,705,394; 5,128,419; 5,389,548; 5,986,030; and GB 1,141,147 describe the use of fluorescent tags in polymers primarily in the field of wastewater treatment, which are incorporated herein by reference. Additional general discussions regarding fluorescent molecular tags may found in Berlman, I. B., Handbook of Fluorescence Spectra of Aromatic Molecules, Second Edition, Academic Press (1971); Czamik, A. W., Ed., Fluorescent Chemosensors for Ion and Molecule Recognition (ACS Symposium Series 538), American Chemical Society (1993); Drexhage, K. H., “Structure and Properties of Laser Dyes” in Dye Lasers, Third Edition, F. P. Schäfer, Ed., Springer-Verlag, (1990) pp. 155-200; Green, F. J., The Sigma-Aldrich Handbook of Stains, Dyes and Indicators, Aldrich Chemical Company (1990); Griffiths, J., Colour and Constitution of Organic Molecules, Academic Press (1976); Johnson, I. D., Ryan, D. and Haugland, R. P., “Comparing Fluorescent Organic Dyes for Biomolecular Labeling” in Methods in Nonradioactive Detection, G. C. Howard, Ed., Appleton and Lange (1993) pp. 47-68; Kasten, F. H., “Introduction to Fluorescent Probes: Properties, History and Applications” in Fluorescent and Luminescent Probes for Biological Activity, W. T. Mason, Ed., Academic Press (1993) pp. 12-33; Krasovitskii, B. M. and Bolotin, B. M., Organic Luminescent Materials, VCH Publishers (1988); Lakowicz, J. R., Ed., Topics in Fluorescence Spectroscopy: Probe Design and Chemical Sensing (Volume 4), Plenum Publishing (1994); and Mason, W. T., Ed., Fluorescent and Luminescent Probes for Biological Activity, Second Edition, Academic Press (1999Marriott, G., Ed., Caged Compounds).

Candidate dye molecules for use with the fluorescence embodiment of the method of the present invention are available commercially. Examples of commercially available include Molecular Probes Inc. (Eugene, Oreg.) and Polysciences Inc. (Warrington, Pa.). For instance, Polysciences, Inc supplies fluorescent vinylic monomers such as those listed in Table 1 which are useful for tagging macromolecules.

TABLE 1
Fluorescent Monomers Suitable for Use
in the Method of the Present Invention

| | Excitation | Emission |
|---|---|---|
| Molecule | Max | Max |
| 9-Anthracenylmethyl methacrylate | 362 nm | 407 nm |
| 3,8-Dimethacryloyl Ethidium Bromide | 439 nm | 512 nm |
| (PolyFluor ® 512) | | |
| Fluorescein dimethacrylate | 470 nm | 511 nm |
| (PolyFluor ® 511) | | |
| Methacryloxyethyl thiocarbamoyl rhodamine B | 548 nm | 570 nm |
| (PolyFluor ® 570) | | |
| O-Methacryloyl Hoechst 33258 | 355 nm | 497 nm |
| (PolyFluor ® 497) | | |
| 2-Naphthyl methacrylate | 285 nm | 345 nm |
| (PolyFluor ® 345) | | |
| 1-Pyrenylmethyl methacrylate | 339 nm | 394 nm |
| (PolyFluor ® 394) | | |

In another aspect of the present invention, the method of detecting additives in metal plating solutions is carried out in a method employing Raman spectroscopy. Copending U.S. patent application Ser. No. 10/196,491 filed on Jul. 15, 2002 by Microbar System, Inc, entitled “Method and System for Analytes Determination for Metal Plating, describes the use of Raman spectroscopy in identifying chemical analytes in metal plating solutions, and is incorporated herein by reference. A Raman sensitive functionality is incorporated into the molecular structure of an additive to increase the sensitivity of the additive to the Raman spectroscopy. Raman sensitivity increases with the symmetry of the structure of additives. Examples of Raman sensitive functionality include: nitrites, Si—Si, C—S—S—C, —CSH amines, quatemerized amines, carbonyls, ketones, hydrazones, nitriles, saturated and unsaturated carbon, alcohols, organic acids, azo, cyanates, sulfides, sulfones, sulfonyl, and the like. For more examples of Raman sensitive functionality, we refer to: Langes Handbook of Chemistry, McGraw Hill, N.Y., 1992, 14th ed., pp. 7.75-7.92. The Raman emission preferably does not occur in a region of the spectrum obscured by water scattering. Typically, scattering by water is not a problem for wavenumbers in the range of approximately 500 to 2500 cm⁻¹. Proper choice of the Raman tag is dictated by its relative sensitivity and the energy of its Raman shift.

Enhancement of the Raman spectroscopy signal from a molecule signal may be achieved by judicious choice of a molecular fragment with a significant Raman “cross-section” or β, that is, a molecular bond with high scattering response. Raman “cross-section” is analogous to “extinction coefficient”, or magnitude of absorption as derived from Beer's law in absorption spectroscopy. Lists of Raman β magnitudes have been compiled and are available in the public domain such as for instance in McCreery, Raman Spectroscopy for Chemical Analysis, John Wiley and Sons, Inc., New York, 2000, pp. 20-30. In general, the magnitude of β is a strong function of the quantity of polarizable π-electrons, such as for example those found in electron rich or aromatic or extended π-electron systems, and S—S bonds, in a molecule. Therefore, dye molecules whose structures include these functional features have larger Raman cross-sections. For example, at an excitation wavelength of 514.5 nm, Raman β values for the simplest series of aromatic compounds is as follows: anthracene>>napthalene>benzene. Dye molecules may exhibit larger β magnitudes as well as significant absorption extinction coefficients and fluorescent response. Enhancement of the Raman signal from a molecule may also be achieved by resonance effects. When the incident light approaches excitation energy or an electronic absorption of a molecule such as β-carotene, a significant increase in Raman cross-section may be observed due to energy transfer or vibration enhancement. These resonance effects rely on choice of laser and absorption maximum for the molecular tag. Table 2 lists Raman shifts in cm⁻¹ and cross section (β) values in cm² molecule⁻¹ steradian⁻¹) for several functional groups that are preferably used in tagging analyte molecules in metal plating baths according to one embodiment of the present invention.

TABLE 2
Raman Shifts and Cross Sections
for Some Exemplary Functionalities

| | Laser λ | Raman | β × 10³⁰ (cm² |
|---|---|---|---|
| Sample | (nm) | Shift (cm⁻¹) | molecule⁻¹ sr⁻¹) |
| SO₄⁻² in H₂O (as Na₂SO₄) | 514.5 | 981 | 9.9 |
| CH₃CN | 514.5 | 918 | 1.01 |
| CH₃CN | 514.5 | 2249 | 8.2 |
| H₂O, liquid | 514.5 | 1595 | 0.11 |
| ClO₄ in H₂O | 514.5 | 932 | 12.7 |
| Cyclohexane, neat | 514.5 | 802 | 8.3 |
| Cyclohexane in benzene | 514.5 | 801 | 11.9 |
| Glucose in H₂O | 514.5 | 1126 cm⁻¹ | 5.6 |
| 1.4 Bis-(2-methylstyryl) | 514.5 | 1583 | 6200 |
| benzene in benzene | | | |
| 1.4 Bis-(2-methylstyryl) | 514.5 | 1177 | 1900 |
| benzene in benzene | | | |
| β-Carotene in benzene | 514.5 | 1520 | 1.1 × 10⁷ |
| β-Carotene in benzene | 514.5 | 1005 | 2.2 × 10⁶ |
| Benzene, neat | 514.5 | 992 | 28.6 |
| Naphthalene in benzene | 514.5 | 1382 | 82 |
| Anthracene in benzene | 514.5 | 1402 | 540 |
| C₆H₅NO₂ | 488 | 1345 | 10 |
| H₂ (gas) | 488 | 4161 | 7.9 |
| CO (gas) | 488 | 2145 | 3.3 |
| C₆H₅CH₃ | 514.5 | 1002 | 13.8 |
| C₆H₅NO₂ | 514.5 | 1345 | 89 |
| CCl₄ | 514.5 | 459 | 16.9 |
| 1% C₆H₆ in CH₃CN | 514.5 | 992 | 19.2 |
| | 220 | 992 | 15,200 |
| CHCl₃ liquid | 785.0 | 3032 | 0.58 |
| | 785.0 | 758 | 0.57 |
| | 785.0 | 667 | 1.19 |
| | 785.0 | 364 | 1.14 |
| | 785.0 | 261 | 1.29 |
| | 514.5 | 1332 | 3.4 |

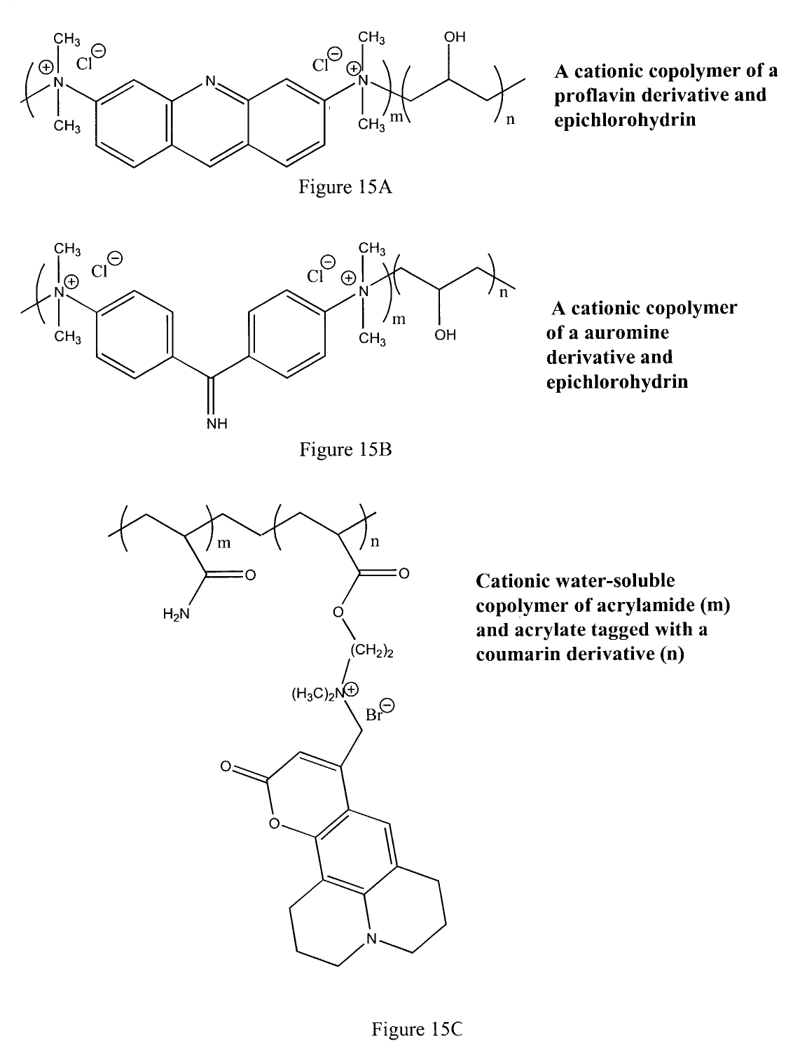

In a further embodiment of the present invention, a method is provided for synthesizing plating bath additive molecules containing chromophoric functionalities as described above. The added chromophore preferably contains primary, secondary or tertiary amine functionality that undergoes an addition or step polymerization reaction with a bifunctional electrephilic chemical structure, such as for instance epichlorohydrin. Examples of electrophilic bifunctional molecules include aliphatic or aromatic molecules that are substituted with two leaving groups, such as halogen atoms. Monofunctional amines, are incorporated as a polymer end groups or as pendant groups attached to a polymer chain. Difunctional amines are incorporated linearly into the polymer backbone. Polymerization of trisubstituted or greater amines may result in branched structures. Many dye molecules feature pendant amine functionality that may preferably be used in an addition or condensation type polymerization. Examples of absorbing and/or fluorescent species which, when modified to contain nucleophilic amino groups, may be used to prepare tagged polymers include substituted aromatic hydrocarbons (e.g. naphthalenes, anthracenes, pyrenes, perylenes, stilbenes), substituted five-membered heterocyclic compounds (e.g. furans, thiophenes, pyrroles, oxazoles, oxadiazoles, thiadiazoles, pyrazolines, pyrazoles), condensed five-membered heterocyclic compounds (e.g. benzofurans, benzothiophenes, indoles, benzoxazoles, benzimidazoles, benzothiazoles, benzotriazoles, dibenzofurans, dibenzothiophenes, carbazoles), six-membered nitrogen heterocycles (e.g. pyridines, quinolines, acridines, pyrazines, qinoxalines, phenazines), six-membered oxygen heterocycles: zanthenes (e.g. fluoresceins, rhodamines), other six-membered heterocycles (e.g. benzoxanthenes, benzothioxanthenes, phenothiazines, phenoxazines), unsaturated ketones (e.g. anthrones, benzanthrones, xanthones, thioxanthones, acridines, fluorenones, condensed quinones, indigoids, thioindigoids), and unsaturated acid derivatives (e.g. terephthalic acid esters, phthalic anhydride derivatives, coumarins, carbostyryls, oxazolones, naphthalimides). FIGS. 15A and 15B show exemplary polymer structures formed using the method of the present invention. These examples are in no way limiting but are included to illustrate the wide variety of molecules that may be employed in the method of the present invention. Because chromophoric groups are typically chosen to be very strongly absorbing or fluorescing and are further chosen to have spectroscopic activity in low absorbance regions of the bath spectrum, a concentration of as little as 1 ppm of chromophore in a polymer chain is sufficient to facilitate detection by the methods described herein. Thus, in synthesizing a long-chain polymeric bath additive, substitution of approximately one chromophonrc monomer for every million standard monomers is sufficient to create an analyte that is readily detectable by the methods of the present invention.

Another embodiment of the present invention entails attachment of a chromophoric moeity to a molecule containing polymerizable vinylic functionality as in the example in FIG. 15C. In this fashion, the vinylic functionality undergoes a free-radical polymerization in which the resulting polymer contains some fraction of chromophore. It is important to note that the macromolecule may be a homopolymer or a copolymer derived from a number of different monomers. Optimization of chromophore content or mole percent chromophore may be achieved via copolymerization. It is also important for the resulting macromolecule maintain water solubility and is stable at the pH of the bath as well as it's electrochemical potential. Table 1 lists commercially available examples of monomers that may be used in this embodiment.

In a preferred embodiment of the present invention, the method further provides for quantifying concentrations of metal plating bath additives based on the spectra collected using one or more of the methods of the aforementioned embodiments of the present invention. This method is described below and is further described in part in copending U.S. patent application Ser. No. 10/196,491, the disclosure of which is hereby incorporated in its entirety by reference. The method comprises the steps of preparing and analyzing spectra from standard solutions of expected analytes. Primary and secondary peak height and/or area ratios for each analyte are then calculated. Next, the spectrum for the sample of interest is collected. A first analyte is identified and quantified in a non-overlapped region of the spectrum. The peak height and/or area of overlapping analyte peaks is estimated using primary/secondary height and/or area rations to create a system of linear algebraic equations, and the system of equations is solved.

More specifically, the sample spectrum contains a plurality of peaks, some of which are attributable to Raman scattering and/or light absorbance or fluorescence emissions by analytes of interest such as one or more plating bath additives. In general a spectrum of a solution containing multiple analytes has regions of the spectrum where peaks attributable to more than one analyte overlap. This embodiment of the present invention provides a method for deconvoluting a spectrum comprised of peaks from numerous analytes. Prior to analysis of a sample spectrum, standard spectra are prepared for each analyte expected to be found in the sample. A primary and one or more secondary peaks are identified for each standard. In general, the peak heights and/or areas of each of the primary and one or more secondary peaks vary linearly with the concentration of the analyte. As such, the ratios of the area and/or height of an individual secondary peak to the primary peak as well as to other secondary peaks in the spectrum of a single analyte are approximately constant and independent of the concentration of the analyte. This property is used in conjunction with standard spectra and peak ratios from the expected analytes to differentiate the concentrations of multiple overlapping analytes in a sample spectrum as follows. A region of the sample spectrum containing only a single primary or secondary peak from a first analyte is identified. The concentration of that analyte is determined based on a calibration curve based on the area and/or height of that peak in the standard spectrum. If, for example, a secondary peak from the first analyte occurs in the same region of the sample spectrum as the primary peak of a second analyte, the total area and/or height observed on the sample spectrum in the wavelength region of the primary peak of the second analyte is reduced by the expected height and/or area under the secondary peak of the first analyte based on the concentration of the first analyte known from the primary peak height and/or area of the first analyte, the calibration curve, and the-known ratio of the height and/or area of the primary and secondary peaks of the first analyte. This process is repeated as necessary to quantify all of the analytes of interest in a sample spectrum. Overlapping of multiple peaks from multiple analytes in a single wavelength region of a sample spectrum requires construction of a matrix of linear algebraic equations. The resulting matrix can be readily solved to identify the concentrations of each of the analytes by one of skill in the art provided that at least one peak of one analyte occurs alone in a discrete region of the spectrum.

Bilinear projection methods, like PCA (Principal Components Analysis), PCR (Principal Components Regression), PLS (Partial Least Squares regression, or Projection to Latent Structures regression) extract systematic information from the combination of many measurement variables. They also offer great interpretation features, to visualize sample patterns and variable relationships in easily interpretable graphical pictures. The multivariate models can then be used for indirect measuring, data reduction, exploration, prediction or classification/identification. These methods are easy to, use and handle most multivariate problems despite intercorrelations, noise, errors, missing data, or extreme data table dimensions. Sub-routines and algorithms such as those featured in the aforementioned commercially available software packages may also be used to streamline the data analysis process or for conversion of peak height or areas directly to additive concentrations.

### EXPERIMENTAL

A number of experiments were conducted according the method and system of the present invention. These experiments are intended for illustration purposes only, and are not intended to limit the scope of the present invention in any way.

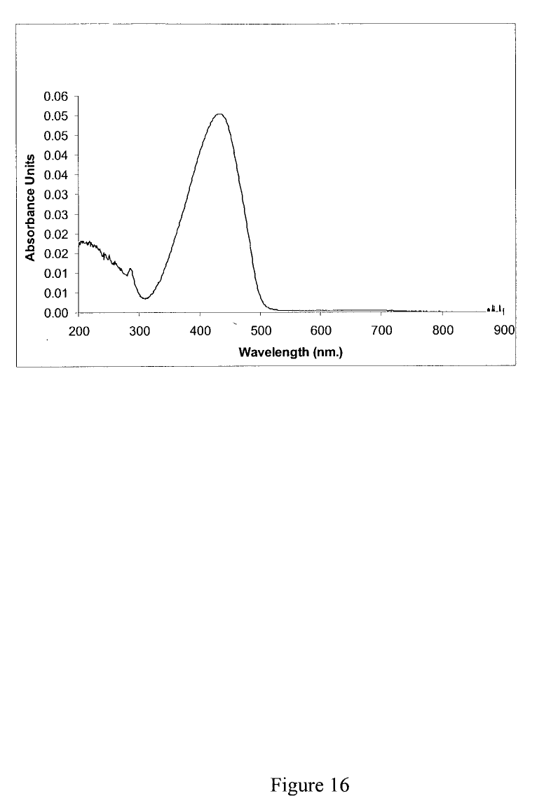

In one example, illustrated in FIG. 16, a solution of one part per million of tetrazine (Acid Yellow 23) was prepared in an acidic copper sulfate solution containing 17 g L⁻¹ of copper sulfate. FIG. 16 shows the UV-visible absorbance spectrum for this solution, corrected using a 17 g L⁻¹ external reference solution of copper sulfate. As FIG. 16 shows, the tetrazine peak is clear and quantifiable at approximately 425 nm.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

What is claimed is:

1. A method of detecting one or more analytes in a metal plating solution, comprising the steps of:
collecting and analyzing an absorbance spectrum of said plating bath to determine one or more regions of low absorbance;
chemically incorporating a molecular tag into said one or more analytes to form one or more spectrophotometrically enhanced analyte-tag complexes;
analyzing said plating bath using a spectroscopic method to collect a plating bath spectrum, said spectrum containing one or more peaks corresponding to each of said one or more analyte-tag complexes in said bath;
quantifying the concentrations of each of said one or more analytes in said bath based on one or more of the peak height and area of each of said analyte-tag complexes.

2. The method of claim 1 wherein the molecular tag includes one or more functional groups that shifts the wavelength of maximum absorbance for said analyte into one of said regions of low absorbance.

3. The method of claim 1 wherein the molecular tag includes one or more functional groups that makes said analyte-tag complex fluorescent such that said analyte-tag complex has an excitation wavelength in one of said regions of low absorbance and an emission maximum wavelength in one of said regions of low absorbance.

4. The method of one of claims 2 or 3 wherein said molecular tag comprises one or more conjugated or chromophore groups selected from the group consisting of aromatic rings, dienes, diynes, polyenes, nitrites, carbonyl, and disulfides.

5. The method of one of claims 2 or 3 wherein said molecular tag comprises a dye molecule that has an absorbance maximum at a wavelength in one of said regions of low absorbance.

6. The method of claim 5 wherein said dye molecule is stable in an acidic metal plating solution.

7. The method of claim 5 wherein said dye molecule is stable in an alkaline metal plating solution.

8. The method of claim 5 wherein said dye molecule maintains its absorbance after being reacted with one of said analytes to form one of said analyte-tag complexes.

9. The method of claim 5 wherein said dye molecule is selected from the group consisting of nitroso, nitro, azo diazo, triazo, polyazo, azoic, stilbene, carotenoid, diphenylmethane, triarylamine, xanthene, acridine, quinoline, methine, thiazole, idamine, azine, oxazine, thiazine, thionated aromatic, aminoketone, hydroxyketone, anthraquinone, indigoid, and phthalocyanine compounds.

10. The method of claim 2, wherein said wavelength of maximum absorbance for said analyte-tag complex occurs at a wavelength in the range of approximately 350 to 550 nm.

11. The method of claim 9, wherein said wavelength of maximum absorbance for said analyte-tag complex occurs at a wavelength in the range of approximately 400 to 450 nm.

12. The method of claim 2 wherein said wavelength of maximum absorbance for said analyte-tag complex occurs at a wavelength in the range of approximately 320 to 430nm.

13. The method of claim 2 wherein said wavelength of maximum absorbance for said analyte-tag complex occurs at a wavelength in the range of approximately 580 to 900 nm.

14. The method of claim 1 wherein the molecular tag includes one or more functional groups that increases the intensity of Raman emissions from said analyte-tag complex in response to excitation by incident light at a wavelength in one of said regions of low absorbance.

15. The method of claim 14 wherein said Raman sensitive functionality comprises a chemical bond with a large Raman cross section (β).

16. The method of claim 14 wherein said Raman sensitive functionality is selected from the group consisting of carbonyls, ketones, hydrazones, saturated and unsaturated carbon, alcohols, organic acids, azo, cyanater, sulfiden, sulfores, and sulfonyl.

17. The method of claim 1 wherein said molecular tag is incorporated into said one or more analyte-tag complexes by one or more chemical bonds.

18. The method of claim 17 wherein said one or more chemical bonds are selected from the group consisting of ionic bonds, covalent bond, and hydrogen bonds.

19. The method of claim 1 wherein said one or more analytes are polymers, and said molecular tag is attached at either the backbone or as a pendant group of the polymer.

20. The method of claim 19 wherein said polymers are formed by a method selected from the group consisting of free radical polymerization and condensation polymerization.

21. The method of claim 1 wherein said molecular tag includes primary, secondary, or tertiary amine functionality.

22. A method of detecting one or more analytes in a metal plating solution, comprising the steps of:
collecting and analyzing an absorbance spectrum of said plating bath to determine one or more regions of low absorbance;
chemically incorporating a molecular tag that has one or more absorbance bands in one of said regions of low absorbance into said one or more analytes to form one or more spectrophotometrically enhanced complexes;
analyzing said plating bath using absorbance spectroscopy to collect a plating bath spectrum, said spectrum containing one or more peaks corresponding to each of said one or more analyte complexes in said bath;
quantifying the concentrations of each of said one or more analytes in said bath based on one or more of the peak height and area of the peaks of each of said analyte complexes.

23. A method of detecting one or more analytes in a metal plating solution, comprising the steps of:
collecting and analyzing an absorbance spectrum of said plating bath to determine one or more regions of low absorbance;
chemically incorporating a fluorescent molecular tag whose excitation and emission wavelengths are in one of said regions of low absorbance into said one or more analytes to form one or more spectrophotometrically enhanced complexes;
analyzing said plating bath using fluorescence spectroscopy to collect a plating bath spectrum, said spectrum containing one or more fluorescent emission peaks corresponding to each of said one or more analyte complexes in said bath;
quantifying the concentrations of each of said one or more analytes in said bath based on one or more of the peak height and area of each of said analyte complexes.

24. A method of detecting one or more analytes in a metal plating solution, comprising the steps of:
collecting and analyzing an absorbance spectrum of said plating bath to determine one or more regions of low absorbance;
chemically incorporating a molecular tag into said one or more analytes to form one or more spectrophotometrically enhanced complexes, said molecular tag increasing the intensity of Raman emissions from said analyte-tag complex in response to excitation by incident light at a wavelength in one of said regions of low absorbance;
analyzing said plating bath using Raman spectroscopy to collect a Raman spectrum, said spectrum containing one or more Raman emission peaks corresponding to each of said one or more analyte complexes in said bath;
quantifying the concentrations of each of said one or more analytes in said bath based on one or more of the peak height and area of each of said analyte complexes.

25. A method of deconvoluting overlapping peaks from two or more analytes in the spectrum of a plating bath collected according to any of claims 1 to 3, 14, and 22 to 24 comprising the steps of:
preparing and analyzing a standard spectrum for each of said analytes;
calculating a ratio of the height and/or area of a primary peak height to the height and/or area of one or more secondary peak for each analyte based on said standard spectra;
identifying and quantifying a first of said plurality of analytes in a region of said spectrum of said plating bath;
estimating a peak metric attributable to each of one or more of said plurality of analytes with a peak in an overlapping region of said spectrum of said plating bath based on said primary/secondary peak height and and/or area ratios;
creating a system of coupled linear algebraic equations based on said estimated peak metrics; and
solving said system of coupled linear algebraic equations using linear algebraic techniques.
